(19) United States
(12) Patent Application Publication
(10) Pub. No.: US 2023/0150891 A1
(43) Pub. Date: May 18, 2023

(54) PROCESS FOR PRODUCING FOAMED CONCRETE

(71) Applicant: Wacker Chemie AG, Munich (DE)

(72) Inventors: Holger BIENERTH, München (DE); Josef BRUMMER, Simbach (DE); Klaus-Jürgen EDER, Mitterskirchen (DE); Harald ZEH, Burghausen (DE)

(73) Assignee: Wacker Chemie AG, Munich (DE)

(21) Appl. No.: 17/909,443

(22) PCT Filed: Mar. 10, 2020
(86) PCT No.: PCT/EP2020/056347

§ 371 Date: Sep. 6, 2022

(51) Int. Cl. C04B 38/10; C04B 28/06

(52) U.S. Cl. CPC C04B 38/10; C04B 28/06; C04B 2103/48

(57) ABSTRACT

A process for producing foamed concrete includes introducing air pores into aqueous concrete compositions by one or more air pore formers and/or by introducing air. The aqueous concrete compositions are based on one or more foam stabilizers, one or more protective colloid-stabilized polymers of ethylenically unsaturated monomers in the form of aqueous dispersions or water-redispersible powders, 30% to 95% by weight of cement, based on the dry weight of the components for production of the concrete compositions, optionally one or more fillers, and optionally one or more additives.

The invention relates to processes for producing foamed concrete, to concrete compositions for production of foamed concrete, and to methods of applying the foamed concrete, especially for production, for example, of precast concrete parts, floors or walls.

Conventional concrete compositions are based on hydraulically setting binders, such as cement, fillers and optionally further additives. Concrete compositions are made up by addition of water and converted to fresh concrete, which can then be used for production of precast concrete parts, for example. Setting of the fresh concrete results in set concrete. Depending on the field of use, particular demands are made on the set concrete. For instance, the market is increasingly demanding set concrete having improved insulation properties, especially for sound insulation or thermal insulation. This is because, if the set concrete itself already has insulating properties, it is possible to dispense with the complex application of insulation material, such as EPS insulation panels or mineral wool, which saves resources and labor. Moreover, insulating concrete has the advantage over conventional insulation materials of being noncombustible and additionally having good adhesion on various bases. Foamed concrete is suitable for such purposes. Foamed concrete implicitly contains air pores to an increased extent.

For foamed concrete, on account of its air pore content, the challenge is to attain the desired mechanical properties, such as bending tensile strength, compressive strength or tensile bond strength, to limit the penetration of water, or to assure the stability or durability of the foamed concrete overall.

Foamed concrete is known, for example, from CN108484211 or CN 108529940. DE4209897 and DE3909083 describe gypsum-based foamed mortars. GB20047636 is concerned with silicate foams. DE2056255 discloses foaming agents for gypsum and cement compositions. DE4009967 describes the addition of pore formers to mortars, wherein the pore formers have been provided with an inactivating coating, such that the pore-forming action of the pore formers in the fresh concrete is subject to a time delay.

Mortars are generally applied in thinner layers than concrete and often serve as render or for bonding of, for example, bricks, tiles, adhesive panels or other articles. Consequently, adhesion properties are often at the forefront in the case of mortars, whereas concrete is generally used for construction of built structures, for example for walls or floors, and hence has a load-bearing role, such that mechanical demands on set concrete are quite different than those on mortar. Gypsum is generally hygroscopic and not water-resistant.

Against this background, the problem addressed is that of providing foamed concrete having improved mechanical properties, such as bending tensile strength, compressive strength and tensile bond strength. Moreover, the foamed concrete should be crack-bridging if possible and should have high resistance to water stress. Overall, the foamed concrete should be characterized by high durability.

The invention provides processes for producing foamed concrete, in which air pores are introduced into aqueous concrete compositions by means of one or more air pore formers and/or by introducing air,

wherein the aqueous concrete compositions are based on

one or more foam stabilizers,

one or more protective colloid-stabilized polymers of ethylenically unsaturated monomers in the form of aqueous dispersions or water-redispersible powders,

30% to 95% by weight of cement, based on the dry weight of the components for production of the concrete compositions,

optionally one or more fillers and optionally one or more additives.

The invention further provides concrete compositions for production of foamed concrete, based on

one or more foam stabilizers,

one or more air pore formers,

optionally one or more fillers and

optionally one or more additives, characterized in that one or more protective colloid-stabilized polymers of ethylenically unsaturated monomers are present in the form of aqueous dispersions or water-redispersible powders and

30% to 95% by weight of cement, based on the dry weight of the concrete compositions.

The term foamed concrete generally encompasses fresh concrete and set concrete.

Air can be introduced into aqueous concrete compositions, for example, by mechanically mixing the aqueous concrete compositions with air. For this purpose, the aqueous concrete compositions may be beaten, for example. Mechanical mixing is preferably effected by means of stirrer paddles, mixing coils, paddle stirrers, propellers stirrers or perforated plate stirrers. Particular preference is given to mixing coils with perforated sheet metal. It is also possible to use foam generators. Foam generators are commercially available machines for generating foam. It is also possible to blow air into the aqueous concrete compositions. The air that is introduced into the aqueous concrete compositions preferably has a pressure above ambient pressure, more preferably of 1.1 to 10 bar, especially preferably 1.5 to 6 bar and most preferably of 2 to 3 bar. The FIGURES in bar are based here on absolute pressure. The air is preferably at a temperature of 5° C. to 35° C., especially ambient temperature.

In a preferred embodiment, air pores are introduced into the aqueous concrete compositions by means of one or more air pore formers and additionally by introduction of air.

Preferred air pore formers are ammonium salts or alkali metal salts of the hydrogencarbonates or carbonates, especially the ammonium or sodium or potassium salts thereof. Particular preference is given to hydrogencarbonates. Most preferred is sodium hydrogencarbonate. The air pore formers preferably do not include any alkaline earth metal carbonate. Air pore formers have a grain size of preferably 10 μm to 1 mm, more preferably of 100 μm to 800 μm and most preferably 200 μm to 700 μm.

The concrete compositions are based to an extent of preferably 0.01% to 10% by weight, more preferably 0.05% to 5% by weight and most preferably 0.1% to 3% by weight of air pore formers, based on the dry weight of the components for production of the concrete compositions.

It is possible, for example, to use surfactant-, polymer-, protein- or enzyme-based foam stabilizers.

Examples of surfactants as foam stabilizers are olefinsulfonic acids; fatty acids, having preferably 16 to 18 carbon atoms, or salts thereof; fatty alcohols, having preferably 10 to 18 carbon atoms; alkylphenols or hydroxyalkylphenols having preferably alkyl chains having 10 to 18 carbon atoms; alkyl and alkylaryl ether sulfates having preferably 8 to 18 carbon atoms in the hydrophobic radical and preferably 1 to 50 ethylene oxide units; sulfonates, especially alkylsulfonates having preferably 8 to 18 carbon atoms, alkylarylsulfonates, preferably having alkyl radicals having 8 to 18 carbon atoms, esters or monoesters of sulfosuccinic acid with preferably monohydric alcohols or alkylphenols having preferably 4 to 15 carbon atoms in the alkyl radical, where these alcohols or alkylphenols may also have been ethoxylated with 1 to 40 ethylene oxide units; partial phosphoric esters, especially alkyl or alkylaryl phosphates having 8 to 20 carbon atoms in the organic radical, alkyl ether phosphates and alkylaryl ether phosphates having 8 to 20 carbon atoms in the alkyl or alkylaryl radical and 1 to 50 EO units; alkyl polyglycol ethers, preferably having 8 to 40 EO units and alkyl radicals having 8 to 20 carbon atoms; alkylaryl polyglycol ethers, preferably having 8 to 40 EO units and 8 to 20 carbon atoms in the alkyl and aryl radicals; ethylene oxide/propylene oxide (EO/PO) block copolymers, preferably having 8 to 40 EO or PO units; N-methyl taurides, preferably of higher fatty acids, having preferably 10 to 18 carbon atoms; fatty acid alkylolamides, such as mono- or diethanolamides of fatty acids; amine oxides or phosphine oxides, such as cocodimethylamine oxide or cocodimethylphosphine oxide of the general formula R—N(CH₃)₂═O or R—P(CH₃)₂═O; ampholytes, such as sodium cocoyl dimethylaminoacetate or sulfobetaine; phosphoric esters, especially of long-chain alcohols, having preferably 10 to 18 carbon atoms or of alcohols that have been ethoxylated with 1 to 4 mol of ethylene oxide and have 8 to 10 carbon atoms in the molecule.

An EO unit is an ethylene oxide unit and a PO unit is a propylene oxide unit. The aforementioned acids may also be in the form of their salts, especially ammonium or alkali metal/alkaline earth metal salts. Olefinsulfonic acids contain preferably 10 to 20 carbon atoms. The olefinsulfonic acids preferably bear one or two sulfonic acid or hydroxyalkylsulfonic acid groups. Preference is given here to α-olefinsulfonic acids.

Examples of polymers as foam stabilizers are polyvinylalcohols; polyvinylacetals; polyvinylpyrrolidones; polysaccharides in water-soluble form, such as starches (amylose and amylopectin), celluloses and derivatives thereof, such as carboxymethyl, methyl, hydroxyethyl, hydroxypropyl derivatives, dextrins and cyclodextrins; lignosulfonates; poly(meth)acrylic acid; copolymers of (meth)acrylates with carboxy-functional comonomer units; poly(meth)acrylamide; polyvinylsulfonic acids and water-soluble copolymers thereof; sulfonated melamine-formaldehyde; sulfonated naphthalene-formaldehyde; styrene-maleic acid copolymers and vinyl ether-maleic acid copolymers.

Examples of proteins as foam stabilizers are casein, caseinate, soya protein or gelatin. Proteins are obtainable, for example, by protein hydrolysis, especially of animal proteins, for example from the horns, blood, bones and similar wastes from cattle, pigs and other animal cadavers. Enzymes as foam stabilizers may, for example, be of biotechnological origin.

Preferred foam stabilizers are surfactants; polyvinylalcohols; polyvinylpyrrolidones; celluloses and derivatives thereof, such as carboxymethyl, methyl, hydroxyethyl and hydroxypropyl derivatives; proteins such as casein or caseinate, soya protein and gelatin. Particularly preferred foam stabilizers are surfactants, especially olefinsulfonic acids.

The foam stabilizers have molecular weights of preferably ≤4000 g/mol, more preferably ≤3000 g/mol, even more preferably ≤2500 g/mol, especially preferably ≤1500 g/mol and most preferably ≤1000 g/mol.

The foam stabilizers and protective colloid-stabilized polymers are generally present alongside one another. The foam stabilizers are generally not included in the protective colloid-stabilized polymers.

The concrete compositions are based to an extent of preferably 0.01% to 35% by weight, more preferably 0.05% to 20% by weight and most preferably 0.1% to 10% by weight on foam stabilizers. Surfactants or polymers as foam stabilizers are present to an extent of preferably 0.01% to 10% by weight, more preferably 0.05% to 5% by weight and most preferably 0.1% to 3% by weight. Proteins or enzymes as foam stabilizers are present to an extent of preferably 10% to 35% by weight, more preferably 15% to 30% by weight and most preferably 20% to 25% by weight. The FIGURES in % by weight are based here on dry weight of the components for production of the concrete compositions.

The concrete compositions are based to an extent of preferably 0.5% to 20% by weight, more preferably 1% to 15% by weight and most preferably 2% to 9% by weight on protective colloid-stabilized polymers of ethylenically unsaturated monomers, based on the dry weight of the components for production of the concrete compositions.

The polymers of ethylenically unsaturated monomers are based, for example, on one or more monomers selected from the group comprising vinyl esters, (meth)acrylic esters, vinylaromatics, olefins, 1,3-dienes and vinyl halides.

Suitable vinyl esters are, for example, those of carboxylic acids having 1 to 15 carbon atoms. Preference is given to vinyl acetate, vinyl propionate, vinyl butyrate, vinyl 2-ethylhexanoate, vinyl laurate, 1-methylvinyl acetate, vinyl pivalate and vinyl esters of α-branched monocarboxylic acids having 9 to 11 carbon atoms, for example VeoVa9R or VeoVa10R (trade names of Resolution). Particular preference is given to vinyl acetate.

Suitable monomers from the group of acrylic acid or methacrylic esters are, for example, esters of unbranched or branched alcohols having 1 to 15 carbon atoms. Preferred methacrylic esters or acrylic esters are methyl acrylate, methyl methacrylate, ethyl acrylate, ethyl methacrylate, propyl acrylate, propyl methacrylate, n-butyl acrylate, n-butyl methacrylate, t-butyl acrylate, t-butyl methacrylate, 2-ethylhexyl acrylate.

Particular preference is given to methyl acrylate, methyl methacrylate, n-butyl acrylate, t-butyl acrylate and 2-ethylhexyl acrylate.

Preferred vinylaromatics are styrene, methylstyrene and vinyltoluene. A preferred vinyl halide is vinyl chloride. The preferred olefins are ethylene and propylene, and the preferred dienes are 1,3-butadiene and isoprene.

It is optionally possible to include in the copolymer 0% to 10% by weight, preferably 0.1% to 5% by weight, based on the total weight of the monomers, of auxiliary monomers. Examples of auxiliary monomers are ethylenically unsaturated mono- and dicarboxylic acids, preferably acrylic acid, methacrylic acid, fumaric acid and maleic acid; ethylenically unsaturated carboxamides and carbonitriles, preferably acrylamide and acrylonitrile; mono- and diesters of fumaric acid and maleic acid, such as the diethyl and diisopropyl esters, and maleic anhydride; ethylenically unsaturated sulfonic acids or salts thereof, preferably vinylsulfonic acid, 2-acrylamido-2-methylpropanesulfonic acid. Further examples are precrosslinking comonomers such as polyethylenically unsaturated comonomers, for example diallyl phthalate, divinyl adipate, diallyl maleate, allyl methacrylate or triallyl cyanurate, or postcrosslinking comonomers, for example acrylamidoglycolic acid (AGA), methylacrylamidoglycolic acid methyl ester (MAGME), N-methylolacrylamide (NMA), N-methylolmethacrylamide, N-methylolallyl carbamate, alkyl ethers such as the isobutoxy ether or ester of N-methylolacrylamide, of N-methylolmethacrylamide and of N-methylolallyl carbamate. Also suitable are epoxy-functional comonomers such as glycidyl methacrylate and glycidyl acrylate. Further examples are silicon-functional comonomers, such as acryloyloxypropyltri(alkoxy)- and methacryloyloxypropyltri(alkoxy)silanes, vinyltrialkoxysilanes and vinylmethyldialkoxysilanes, where the alkoxy groups present may, for example, be ethoxy and ethoxy propylene glycol ether radicals. Also included are monomers having hydroxyl or CO groups, for example hydroxyalkyl methacrylates and acrylates, such as hydroxyethyl, hydroxypropyl or hydroxybutyl acrylate or methacrylate, and compounds such as diacetoneacrylamide and acetylacetoxyethyl acrylate or methacrylate.

Preference is given to copolymers of vinyl acetate with 1% to 50% by weight of ethylene; copolymers of vinyl acetate with 1% to 50% by weight of ethylene and 1% to 50% by weight of one or more further comonomers from the group of vinyl esters having 1 to 12 carbon atoms in the carboxyl radical, such as vinyl propionate, vinyl laurate, vinyl esters of alpha-branched carboxylic acids having 9 to 13 carbon atoms, such as VeoVa9, VeoVa10, VeoVa11; copolymers of vinyl acetate, 1% to 50% by weight of ethylene and preferably 1% to 60% by weight of (meth)acrylic esters of unbranched or branched alcohols having 1 to 15 carbon atoms, especially n-butyl acrylate or 2-ethylhexyl acrylate; and copolymers with 30% to 75% by weight of vinyl acetate, 1% to 30% by weight of vinyl laurate or vinyl esters of an alpha-branched carboxylic acid having 9 to 11 carbon atoms, and 1% to 30% by weight of (meth)acrylic esters of unbranched or branched alcohols having 1 to 15 carbon atoms, especially n-butyl acrylate or 2-ethylhexyl acrylate, which also contain 1% to 40% by weight of ethylene; copolymers with vinyl acetate, 1% to 50% by weight of ethylene and 1% to 60% by weight of vinyl chloride; where the polymers may also contain the auxiliary monomers mentioned in the amounts mentioned, and the FIGURES in % by weight add up to 100% by weight in each case.

Preference is also given to (meth)acrylic ester polymers such as copolymers of n-butyl acrylate or 2-ethylhexyl acrylate or copolymers of methyl methacrylate with n-butyl acrylate and/or 2-ethylhexyl acrylate; styrene-acrylic ester copolymers with one or more monomers from the group of methyl acrylate, ethyl acrylate, propyl acrylate, n-butyl acrylate, 2-ethylhexyl acrylate; vinyl acetate-acrylic ester copolymers with one or more monomers from the group of methyl acrylate, ethyl acrylate, propyl acrylate, n-butyl acrylate, 2-ethylhexyl acrylate and optionally ethylene; styrene-1,3-butadiene copolymers; where the polymers may also contain the auxiliary monomers mentioned in the amounts mentioned, and the FIGURES in % by weight add up to 100% by weight in each case.

Most preferred are copolymers with vinyl acetate and 5% to 50% by weight of ethylene; or copolymers with vinyl acetate, 1% to 50% by weight of ethylene and 1% to 50% by weight of a vinyl ester von α-branched monocarboxylic acids having 9 to 11 carbon atoms; or copolymers with 30% to 75% by weight of vinyl acetate, 1% to 30% by weight of vinyl laurate or vinyl esters of an alpha-branched carboxylic acid having 9 to 11 carbon atoms, and 1% to 30% by weight of (meth)acrylic esters of unbranched or branched alcohols having 1 to 15 carbon atoms, which also contain 1% to 40% by weight of ethylene; or copolymers with vinyl acetate, 5% to 50% by weight of ethylene and 1% to 60% by weight of vinyl chloride.

The monomers and the proportions by weight of the comonomers are selected so as to result in a glass transition temperature Tg of −25° C. to +35° C., preferably −10° C. to +25° C., more preferably −10° C. to +20° C. The glass transition temperature Tg of the polymers can be ascertained in a known manner by means of differential scanning calorimetry (DSC). The Tg can also be calculated in advance approximately by means of the Fox equation. According to Fox T. G., Bull. Am. Physics Soc. 1, 3, page 123 (1956): 1/Tg=x1/Tg1+x2/Tg2+ . . . +xn/Tgn, where xn represents the mass fraction (% by weight/100) of monomer n, and Tgn is the glass transition temperature in kelvin of the homopolymer of the monomer n. Tg values for homopolymers are listed in Polymer Handbook 2nd Edition, J. Wiley & Sons, New York (1975).

The polymers are generally prepared in an aqueous medium and preferably by the emulsion or suspension polymerization method—as described, for example, in DE-A 102008043988. In the polymerization, it is possible to use the standard protective colloids and/or emulsifiers, as described in DE-A 102008043988. The polymers in the form of aqueous dispersions may, as described in DE-A 102008043988, be converted to corresponding water-redispersible powders. In general, a drying aid is used, preferably the aforementioned polyvinylalcohols.

The polymers may take the form, for example, of aqueous dispersions, especially protective colloid-stabilized aqueous dispersions. Preferred protective colloids are polyvinylalcohols, such as partly hydrolyzed or fully hydrolyzed polyvinylalcohols, especially having a hydrolysis level of 80 to 100 mol %. Particular preference is given to partly hydrolyzed polyvinylalcohols having a hydrolysis level of 80 to 94 mol % and a Höppler viscosity, in 4% aqueous solution, of especially 1 to 30 mPas (Höppler method at 20° C., DIN 53015). The protective colloids mentioned are obtainable by means of methods known to the person skilled in the art. The protective colloids are generally present in a total amount of 1% to 20% by weight, based on the total weight of polymers.

The polymers are preferably in the form of protective colloid-stabilized, water-redispersible powders. Dispersing of the protective colloid-stabilized, water-redispersible polymer powders leads to protective colloid-stabilized polymers in the form of aqueous redispersions. The powders preferably contain 3% to 30% by weight, more preferably 5% to 20% by weight, of polyvinylalcohols, especially the aforementioned polyvinylalcohols, based on the dry weight of the powders.

The protective colloid-stabilized polymers are generally present separately from the air pore formers and/or foam stabilizers. The air pore formers and/or foam stabilizers are generally not coated with the protective colloid-stabilized polymers. The protective colloid-stabilized polymers or the protective colloids or the polymers of the protective colloid-stabilized polymers are generally distinct from the foam stabilizers and any thickeners.

Cement may, for example, be portland cement (CEM I), portland slag cement (CEM II), blast furnace slag cement (CEM III), pozzolan cement (CEM IV), composite cement (CEM V), portland silicate dust cement, portland shale cement, portland limestone cement, trass cement, magnesia cement, phosphate cement, mixed cements or filler cements or quick-setting cement. Examples of quick-setting cement are aluminate cement, calcium sulfoaluminate cements and alumina cement. Preference is given to portland cement CEM I, portland slag cement CEM II/A-S, CEM II/B-S, portland limestone cement CEM II/A-LL, portland fly ash cement CEM II/A-V, portland fly ash slag cement CEM II/B-SV or blast furnace slag cement CEM III/A, CEM III/B, CEM III/B and aluminate cement.

The concrete compositions are cement-based to an extent of preferably 40% to 95% by weight, more preferably 50% to 92% by weight, especially preferably 60% to 91% by weight and most preferably 70% to 90% by weight, based on the dry weight of the components for production of the concrete compositions.

In a preferred embodiment, the concrete compositions contain quick-setting cement, such as aluminate cement, and additionally one or more cements other than quick-setting cement, especially portland cements. Quick-setting cement is particularly advantageous for achievement of the object of the invention.

The concrete compositions are based to an extent of preferably 20% to 70% by weight, more preferably 30% to 60% by weight and most preferably 40% to 50% by weight on quick-setting cement, based on the dry weight of the components for production of the concrete compositions.

The concrete compositions are based to an extent of preferably 25% to 55% by weight, more preferably 35% to 45% by weight and most preferably 45% to 55% by weight on quick-setting cement, based on the total weight of the cement used overall.

The concrete compositions may also comprise one or more thickeners, for example polysaccharides such as cellulose ethers and modified cellulose ethers, cellulose esters, starch ethers, guar gum, xanthan gum, polycarboxylic acids such as polyacrylic acid and partial esters thereof, casein and associative thickeners. Preferred cellulose ethers are methyl cellulose ethers. The thickeners are generally distinct from the foam stabilizers. The thickeners have molecular weights of preferably >4000 g/mol, more preferably ≥10 000 g/mol and most preferably ≥20 000 g/mol. The concrete compositions are based to an extent of preferably ≤5% by weight, more preferably 0.1% to 3% by weight and most preferably 0.5% to 1.5% by weight on thickeners, based on the dry weight of the components for production of the concrete compositions.

The concrete compositions may also comprise one or more pozzolans, for example kaolin, microsilica, diatomaceous earth, fly ash, ground trass, ground blast furnace slag, ground glass, precipitated silica and fumed silica. Preferred pozzolans are kaolin, microsilica, fly ash, ground blast furnace slag, especially metakaolin.

The concrete compositions are based to an extent, for example, of 0.1% to 10% by weight, preferably 0.5% to 5% by weight and more preferably 1% to 3% by weight on pozzolans, based on the dry weight of the components for production of the concrete compositions.

The concrete compositions are preferably based to an extent of 30% by weight, more preferably 20% by weight, more preferably 10% by weight and especially preferably 5% by weight on gypsum, based on the dry weight of the components for production of the concrete compositions. Most preferably, the concrete compositions do not contain any gypsum. Illustrative embodiments of gypsum are α- or β-hemihydrate (CaSO₄.1/2 H₂O), dihydrate, anhydrite, or calcium sulfate obtained in flue gas desulfurization (FGD gypsum). Gypsum generally has an adverse effect on the water stability of the foamed concrete. In addition, gypsum-containing foamed concrete has to be disposed of as controlled waste.

Examples of fillers for the concrete composition are also quartz sand, ground quartz, sand, ground limestone, dolomite, clay, chalk, ground slag sand, white hydrated lime, talc or mica, rubber granules or hard fillers, such as aluminum silicates, corundum, basalt, carbides, such as silicon carbide or titanium carbide. Preferred fillers are quartz sand, ground quartz, ground limestone, calcium carbonate, calcium magnesium carbonate (dolomite), chalk or white hydrated lime. The concrete compositions preferably do not contain any gravel and/or any grit. Fillers have a grain size of preferably

≤2 mm, more preferably ≤1 mm.

The concrete compositions are based to an extent of preferably 0.1% to 10% by weight, more preferably 0.5% to 5% by weight, on fillers, based on the dry weight of the components for production of the concrete compositions. Alternatively, the concrete compositions may also be free of fillers.

The concrete compositions may also comprise lightweight fillers. Lightweight fillers generally refer to fillers of low bulk density, usually of less than 500 g/I. The lightweight fillers are preferably distinct from the aforementioned fillers. Typical lightweight fillers, based on synthetic or natural materials, are substances such as hollow microbeads of glass, polymers such as polystyrene beads, aluminosilicates, silicon oxide, aluminum silicon oxide, calcium silicate hydrate, silicon dioxide, aluminum silicate, magnesium silicate, aluminum silicate hydrate, calcium aluminum silicate, calcium silicate hydrate, aluminum iron magnesium silicate, calcium metasilicate and/or volcanic slag. Preferred lightweight fillers are perlite, Celite, Cabosil, Circosil, Eurocell, Fillite, Promaxon, Vermex and/or wollastonite, and polystyrene.

The concrete compositions are based to an extent of preferably 0.1% to 10% by weight, more preferably 0.5% to 5% by weight and most preferably 1% to 3% by weight on lightweight fillers, based on the dry weight of components for production of the concrete compositions.

In addition, the concrete compositions may also comprise setting accelerators, such as aluminum compounds, silicates, alkali metal/alkaline earth metal hydroxides, nitrates, nitrites, sulfates, borates, or carboxylic acids. Preferred setting accelerators are aluminum salts, aluminates, alkali metal silicates, such as waterglass, alkali metal formates, potassium hydroxide or calcium hydroxide (Ca(OH)₂).

The concrete compositions are based to an extent of preferably 0.1% to 5% by weight, more preferably 0.2% to 2% by weight and most preferably 0.3% to 1% by weight on setting accelerators, based on the dry weight of components for production of the concrete compositions.

In addition, the concrete compositions may comprise fibers, such as natural, modified natural or synthetic fiber materials, based on organic and/or inorganic materials. Examples of natural organic fibers are cotton, hemp, jute, flax, wood fibers, cellulose, viscose, leather fibers or sisal. Examples of synthetic organic fibers are viscose fibers, polyamide fibers, polyester fibers, polyacrylonitrile fibers, Dralon fibers, polyethylene fibers, polypropylene fibers, polyvinylalcohol fibers or aramid fibers. The inorganic fibers may, for example, be glass fibers, carbon fibers, mineral fibers or metal fibers. Preference is given to cotton fibers, polyacrylonitrile fibers and cellulose fibers. The fibers preferably have a length of 1 to 10 mm, 2 to 6 mm and most preferably 3 mm to 4 mm. The fibers may be used in the form of loose fibers, bundled fibers, fibrillated fibers, multifilament fibers or fibers in dose control packages. The concrete compositions are based preferably to an extent of 0.01% to 5% by weight, more preferably 0.1% to 3% by weight and most preferably 0.5% to 2% by weight on fibers, based on the dry weight of components for production of the concrete compositions. Fibers can increase the mechanical stability of the foamed concrete and reduce the propensity of the foamed concrete to cracking.

The concrete compositions may optionally also comprise additives, for example concrete plasticizers, concrete superplasticizers, retardants, film-forming aids, dispersants, concrete plasticizers, hydrophobizing agents, pigments, polymer plasticizers, preservatives, flame retardants (e.g. aluminum hydroxide), finely divided silica. Preferred additives are concrete superplasticizers and plasticizers. Additives are present to an extent of preferably 0% to 20% by weight, more preferably 0.1% to 10% by weight and most preferably 0.5% to 7% by weight, based on the dry weight of components for production of the concrete compositions.

The concrete compositions preferably do not contain any hexafluorosilicic acid, especially any salts of hexafluorosilicic acid, such as calcium, magnesium, zinc or ammonium salts.

The aqueous concrete compositions are produced using preferably 30% to 90% by weight, more preferably 40% to 80% by weight and most preferably 50% to 75% by weight of water, based on the total amount of cement.

For production of the aqueous concrete compositions, unless stated otherwise, the individual constituents thereof may be mixed in standard mixing apparatuses, for example in concrete mixers or readymix concrete mixers. It is also possible to use dissolvers. The mixing generally homogenizes the individual constituents of the concrete compositions.

The concrete compositions are preferably produced by mixing a mixture a) comprising

one or more foam stabilizers,

one or more protective colloid-stabilized polymers of ethylenically unsaturated monomers in the form of aqueous dispersions or water-redispersible powders,

optionally one or more air pore formers,

optionally one or more additives and

water

with 30% to 95% by weight, especially 60% to 90% by weight, of cement, based on the dry weight of components for production of the concrete compositions, optionally one or more fillers and optionally one or more additives.

By the procedure of the invention, particularly advantageous foamed concrete is obtainable. It is well known that arbitrary mixing of the individual foamed concrete constituents does not lead to foamed concrete.

Preferably, mixture a) is mixed with a mixture b) containing 30% to 95% by weight, especially 60% to 90% by weight, of cement, based on the dry weight of components for production of the concrete compositions, optionally fillers and optionally additives.

In a particularly preferred method, the concrete compositions are produced by mixing one or more protective colloid-stabilized polymers of ethylenically unsaturated monomers in the form of aqueous dispersions or water-redispersible powders, optionally fibers and optionally additives, especially thickeners, and water to produce a mixture a1) and then adding to mixture a1) one or more foam stabilizers, optionally one or more air pore formers and optionally additives to obtain mixture a2), and mixing mixture a2) with a mixture b) containing 30% to 95% by weight of cement, especially 60% to 90% by weight of cement, based on the dry weight of the components for production of the concrete compositions, optionally fillers, optionally fibers and optionally additives.

Water is preferably introduced into mixture a), especially into mixture a1). Mixture b) may be an aqueous mixture, especially a dry mixture. When mixture b) is used in the form of a dry mixture, the setting of the concrete compositions is particularly rapid, for example faster by more than a factor of ten or twenty than when aqueous mixtures b) are used.

The mixtures a) or a1) are produced by mixing for preferably 2 to 15 minutes, more preferably 5 to 10 minutes. The mixture a2) is produced proceeding from mixture a1) by mixing for preferably 10 to 60 seconds, especially 20 to 40 seconds. If air pores are being introduced by input of air, mixture a) or a2) is foamed for preferably 2 seconds to 4 minutes. The forming of mixture a) or a2) may be continuous or discontinuous. Continuous foaming can be effected in conventional foam generators. Discontinuous foaming of mixture a) or a2) is effected for preferably 1 to 4 minutes, especially 2 to 3 minutes. Continuous foaming of mixture a) or a2) is effected for preferably 60 seconds, especially 2 to 30 seconds. After combination of mixtures a) and b) or of mixtures a2) and b), mixing is preferably effected for 2 to 60 seconds. Discontinuous mixing of mixtures a) and b) or of mixtures a2) and b) takes preferably 1 to 4 minutes, especially 30 to 60 seconds. Continuous mixing of mixtures a) and b) or of mixtures a2) and b) takes preferably 2 to 30 seconds. The times stated are based generally on the mere mixing. Any times for the conveying of the concrete compositions ready for use are not included.

The introduction of air for generation of air pores is generally effected with mixture a) and more preferably with mixture a2).

The mixing is effected preferably at 5 to 35° C., more preferably 15 to 25° C. Mixtures a), a1) or a2) have a pH of preferably 3 to 8 and more preferably 4 to 7.

Mixtures a) and a2) are preferably in the form of a foam. The foam generally contains air pores. The foam preferably has a cream-like consistency. The foam has a density of preferably 0.05 to 1 g/cm³, more preferably 0.1 to 0.7 g/cm³ and most preferably 0.1 to 0.5 g/cm³. Density can be determined in a conventional manner, for example by filling a vessel with a defined volume of the foam and weighing.

In general, the aqueous concrete compositions containing air pores are applied directly after production thereof, especially without any further processing step.

The aqueous concrete compositions containing air pores can be applied, for example, by application to a base or by introduction into a molded part.

The aqueous concrete compositions containing air pores may be applied manually, by means of 3D printing or by machine, for example by pumping, by introducing into molded parts or formwork, or in some other conventional way. Examples of bases are walls and floors. Examples of molded parts are formwork or other molds.

The foamed concrete (set concrete) has a dry bulk density after 28 days under standard climatic conditions (23° C., 50% relative air humidity) of preferably 10 to 1000 kg/m³, more preferably 100 to 800 kg/m³ (determination method: based on EN 1015-6).

The foamed concrete (set concrete) has a thermal conductivity after 28 days under standard climatic conditions (23° C., 50% relative air humidity) of preferably 20 to 200 mW/mK, more preferably 30 to 150 mW/mK and most preferably 30 to 50 mW/mK. Thermal conductivity is determined with the Netzsch HFM 436 thermal conductivity measuring device according to DIN EN 13163. The measurement is conducted with the “Lambda 10° C.” setting; the lower plate is set to 2.5° C. and the upper plate to 17.5° C. The test substrate is clamped in the middle and the measurement continues until the test substrate has reached a core temperature of 10° C.

The concrete compositions of the invention are suitable, for example, for production of standard precast concrete components, such as insulation panels, concrete blocks, concrete bricks, lightweight concrete bricks, tubbing segments, precast insulation or other concrete moldings. It is also possible to produce floors, especially screeds, lightweight screeds, lofts, flat roofs or terraces, floor slabs or walls, such as cellar walls. Alternatively, it is also possible to apply one or more layers comprising concrete compositions of the invention to walls, floors, screeds or other substrates. It is also possible by concrete formwork to erect built structures. The foamed concrete is also suitable as filler material, for example for levelling beds, for backfilling of doors or windows, or generally for infilling of cavities. The concrete compositions may also be used for backfilling of bricks. It is particularly advantageous to apply the concrete compositions to outside walls, especially for insulation purposes.

In the case of load-bearing concrete products, such as concrete bricks, screeds or outside walls, the foamed concrete has densities of preferably 0.35 to 0.50 g/cm³. In the case of non-load-bearing concrete products such as insulation panels, precast insulation, brick filling or insulation render, the foamed concrete may also have densities of preferably 0.25 to 0.35 g/cm³.

The layer thickness or diameter of the concrete products is preferably ≥1 cm, more preferably ≥5 cm and especially preferably ≥10 cm. The layer thickness or diameter of the concrete products is preferably ≤50 cm, more preferably ≤30 cm and especially preferably ≤20 cm.

The foamed concrete of the invention is notable for very good thermal insulation and sound insulation. It is thus particularly suitable as insulation material. It is also advantageous here that the foamed concrete is noncombustible, by contrast with EPS insulation panels, and additionally adheres very well to substrates, by contrast, for example, with insulation material based on mineral wool or perlite.

Advantageously, the foamed concrete of the invention has very good mechanical properties, such as bending tensile strength, compressive strength or tensile bond strength, and is additionally crack-bridging. Moreover, it is possible by the procedure of the invention to improve the water stability of the foamed concrete, which is manifested, for example, in reduced penetration of water into concrete or in reduced water absorption of the foamed concrete. As a result, the foamed concrete, even in the case of water stress, has very good durability. All these properties can also be achieved with low dry densities of the foamed concrete. Dry density can be adjusted in a simple manner, for example, via the constituents of the concrete compositions, the use amounts thereof or the air pore content.

The examples that follow serve for detailed illustration of the invention and should not be regarded as a restriction in any way.

Production of the Concrete Compositions and the Foamed Concrete Specimens:

First of all, while stirring at room temperature, the constituents of component A (see table 1) were mixed with a dissolver for 5 minutes and then the constituents of component B (see table 1) were added over the course of 30 seconds.

The mixture thus obtained was foamed with a drill fitted with a stirrer paddle at room temperature for 2 minutes. This formed a foam with cream-like consistency.

While stirring with the drill with a stirrer paddle, component C was added to the resultant foam in the form of a dry mixture at room temperature and homogenized for 30 seconds.

Subsequently, the concrete composition from the respective (comparative) example 1 to 3 was processed immediately to give a foamed concrete specimen, as described further down for the respective test method.

TABLE 1
Formulation of the concrete compositions
of (comparative) examples 1 to 3:

| | Comparative | | |
|---|---|---|---|
| | example 1 | Example 2 | Example 3 |
| | [PW] | [PW] | [PW] |
| Component A: | | | |
| Water | 280 | 250 | 260 |
| Polymer dispersion | — | 30 | — |
| Polymer powder | — | — | 20 |
| Tylose MH 60010 P4 | 3.5 | 3.5 | 3.5 |
| PAC hm 6.7/4 fibers | 1 | 1 | 1 |
| Component B: | | | |
| Hostapur OSB | 2 | 2 | 2 |
| Sodium hydrogencarbonate | 2 | 2 | 2 |
| Component C: | | | |
| Milke CEM I 52, 5R | 180 | 180 | 180 |
| Fondu Lafarge | 180 | 180 | 180 |
| Walhalla Edelhydrat | 25 | 25 | 25 |
| Sodium carbonate | 3 | 3 | 3 |

The components of the concrete compositions:
Polymer dispersion:
   polyvinylalcohol-stabilized aqueous dispersion of a vinyl acetate ethylene copolymer (solids content: 60%);
Polymer powder:
   polyvinylalcohol-stabilized, water-redispersible polymer powder of a vinyl acetate-ethylene copolymer having a glass transition temperature of 16° C.;
Tylose MH 60010 P4 (trade name of Shin Etsu):
   etherified methyl hydroxyethyl cellulose (thickener);
PAC hm 6.7/4 fibers (trade name of Schwarzwälder Textilwerke):
   polyacrylonitrile fibers having a length of 4 cm;
Hostapur OSB (trade name of Shin Etsu):
   sodium salt of a C14/C16-α-olefinsulfonic acid;
Milke CEM I 52,5R: portland cement;
Fondu Lafarge (trade name of Imerys):
   calcium aluminate cement (quick-setting cement);
Walhalla Edelhydrat:
   calcium hydroxide (Ca(OH)₂) (latently hydraulic binder).

TABLE 2
Testing results of the foamed concrete specimens
from the (comparative) examples ((C)Ex.) 1 to 3:

| | CEx. 1 | Ex. 2 | Ex. 3 |
|---|---|---|---|
| Dry density [kg/m³] | 380 | 360 | 400 |
| Bending tensile strength [N/mm²] | 0.24 | 0.36 | 0.53 |
| Compressive strength [N/mm²] | 0.46 | 0.73 | 1.10 |
| Tensile bond strength [N/mm²] | 0.06 | 0.08 | 0.12 |
| Water absorption [kg m⁻² min^{-0.5}] | 0.16 | 0.04 | 0.04 |
| Water penetration [mm] | 18 | 3 | 3 |

Testing of the Foamed Concrete Specimens:

The testing was effected after storage of the foamed concrete specimens under standard climatic conditions (23° C., 50% relative air humidity) for 28.

The following properties of the foamed concrete specimens were determined by the following methods:
dry density: based on EN 1015-6;
bending tensile strength: based on DIN18555-3;
compressive strength: based on EN 1015-11;
tensile bond strength on concrete: based on ETAG004;
water absorption: based on EN 1015-18;
water penetration: based on EN 1015-18.

The results of the testing are summarized in table 2.

1-15. (canceled)

16. A process for producing foamed concrete, in which air pores are introduced into aqueous concrete compositions by one or more air pore formers and/or by introducing air, wherein the aqueous concrete compositions are based on
one or more foam stabilizers,
one or more protective colloid-stabilized polymers of ethylenically unsaturated monomers in the form of aqueous dispersions or water-redispersible powders,
30% to 95% by weight of cement, based on the dry weight of the components for production of the concrete compositions,
optionally one or more fillers and optionally one or more additives,
with the proviso that the cement consists of quick-setting cement and one or more portland cements,
wherein the quick-setting cement is selected from the group comprising aluminate cement, calcium sulfoaluminate cements and alumina cement, and
wherein the concrete compositions are based to an extent of 25% to 55% by weight on quick-setting cement, based on the total weight of the cement used overall.

17. A concrete composition for production of foamed concrete, based on one or more foam stabilizers,
one or more air pore formers,
optionally one or more fillers and
optionally one or more additives, characterized in that one or more protective colloid-stabilized polymers of ethylenically unsaturated monomers are present in the form of aqueous dispersions or water-redispersible powders and
30% to 95% by weight of cement, based on the dry weight of the concrete compositions, with the proviso that the cement consists of quick-setting cement and one or more portland cements,
wherein the quick-setting cement is selected from the group comprising aluminate cement, calcium sulfoaluminate cements and alumina cement, and
wherein the concrete compositions are based to an extent of 25% to 55% by weight on quick-setting cement, based on the total weight of the cement used overall.

18. The concrete composition for production of foamed concrete as claimed in claim 17, wherein one or more air pore formers are ammonium salts alkali metal salts of the hydrogen-carbonates or carbonates.

19. The concrete composition for production of foamed concrete as claimed in claim 17, characterized in that foam stabilizers present are
one or more surfactants selected from the group comprising olefinsulfonic acids; fatty acids or salts thereof; fatty alcohols; alkylphenols or hydroxyalkylphenols; alkyl and alkylaryl ether sulfates; alkylsulfonates, alkylarylsulfonates;
esters or monoesters of sulfosuccinic acid; partial phosphoric esters; alkyl polyglycol ethers; alkylaryl polyglycol ethers; ethylene oxide/propylene oxide (EO/PO) block copolymers; N-methyltaurides; fatty acid alkylolamides; amine oxides; or phosgene oxides; sodium cocoyl dimethylaminoacetate; sulfo betaine and phosphoric esters; or
one or more polymers selected from the group comprising polyvinylalcohols;
polyvinylacetals; polyvinylpyrrolidones; polysaccharides in water-soluble form;
lignosulfonates; poly(meth)acrylic acid; copolymers of (meth)acrylates with carboxy-functional comonomer units; poly(meth)acrylamide; polyvinylsulfonic acids and water-soluble copolymers thereof; sulfonated melamine-formaldehyde; sulfonated naphthalene-formaldehyde; styrene-maleic acid copolymers; and vinyl ether-maleic acid copolymers; or
one or more proteins selected from the group comprising casein, caseinate, soya protein; gelatin; and other proteins obtainable by protein hydrolysis of animal proteins; or
enzymes of biotechnological origin.

20. The concrete composition for production of foamed concrete as claimed in claim 17, wherein the concrete compositions are based to an extent of 0.5% to 20% by weight on protective colloid-stabilized polymers of ethylenically unsaturated monomers, based on the dry weight of the concrete compositions.

21. The concrete composition for production of foamed concrete as claimed in claim 17, wherein the polymers of ethylenically unsaturated monomers are based on one or more polymers selected from the group comprising vinyl esters, (meth)acrylic esters, vinylaromatics, olefins, 1,3-dienes and vinyl halides.

22. The concrete composition for production of foamed concrete as claimed in claim 17, wherein 35% to 45% by weight of quick-setting cement is present, based on the total weight of cement present overall,
wherein quick-setting cement is selected from the group comprising aluminate cement, calcium sulfoaluminate cements and alumina cement.

23. The concrete composition for production of foamed concrete as claimed in claim 17, wherein the concrete compositions are free of fillers.

24. The process for producing foamed concrete as claimed in claim 16, further comprising utilizing a concrete composition based on one or more foam stabilizers, one or more air pore formers, optionally one or more fillers, and optionally one or more additives, wherein one or more protective colloid-stabilized polymers of ethylenically unsaturated monomers are present in the form of aqueous dispersions or water-redispersible powders and 30% to 95% by weight of cement, based on the dry weight of the concrete compositions,
with the proviso that the cement consists of quick-setting cement and one or more portland cements,
wherein the quick-setting cement is selected from the group comprising aluminate cement, calcium sulfoaluminate cements and alumina cement, and
wherein the concrete compositions are based to an extent of 25% to 55% by weight on quick-setting cement, based on the total weight of the cement used overall.

25. The process for producing foamed concrete as claimed in claim 16, wherein air is introduced by blowing air into the aqueous concrete compositions and/or by mechanically mixing the aqueous concrete compositions with air.

26. The process for producing foamed concrete as claimed in claim 16, wherein the aqueous concrete compositions are produced by mixing a mixture comprising one or more foam stabilizers,
one or more protective colloid-stabilized polymers of ethylenically unsaturated monomer is in the form of aqueous dispersions or water-redispersible powders,
optionally one or more air pore formers,
optionally one or more additives and
water
with 30% to 95% by weight of cement, based on the dry weight of the components for production of the concrete compositions, optionally one or more fillers and optionally one or more additives.

27. The process for producing foamed concrete as claimed in claim 16, wherein the aqueous concrete compositions are produced by mixing one or more protective colloid-stabilized polymers of ethylenically unsaturated monomers in the form of aqueous dispersions or water-redispersible powders, optionally fibers and optionally additives and water to produce a mixture a1) and
then adding to mixture a1) one or more foam stabilizers, optionally one or more air pore formers and optionally additives to obtain mixture, a2), and
mixing mixture a2) with a mixture b) containing 30% to 95% by weight of cement, based on the dry weight of the components for production of the concrete compositions, optionally fillers, optionally fibers and optionally additives.

28. The process for producing foamed concrete as claimed in claim 27, wherein mixture b) is a dry mixture.

29. The process for producing foamed concrete as claimed in claim 27, wherein air pores are generated by introducing air into mixture a2).

30. A method of applying the foamed concrete from claim 16 by application to a base or by introduction into a molded part.

31. A method of applying the foamed concrete as claimed in claim 30 for production of precast concrete parts, floors, flat roofs, terraces, ground slabs, walls; or
for coating of walls, floors or screeds; or
in concrete formwork; as filler material; or for infilling of bricks.
